(19) United States
(12) Patent Application Publication
(10) Pub. No.: US 2026/0202344 A1
(43) Pub. Date: Jul. 16, 2026

(54) A SYSTEM AND METHOD FOR THE INSPECTION OF CYLINDRICAL CONTAINERS

(71) Applicant: ALTA VISION, SRL, Cartuja Baja (Zaragoza) (ES)

(72) Inventor: Eduardo Héctor TESSORE, Barbastro (Huesca) (ES)

(21) Appl. No.: 19/129,998

(22) PCT Filed: Oct. 25, 2023
(86) PCT No.: PCT/EP2023/079740

§ 371 Date: May 14, 2025

(30) Foreign Application Priority Data
Nov. 15, 2022 (EP) 22383100.9

(51) Int. Cl. G01N 21/88; B65G 15/14; B65G 37/00; B65G 47/244; G01N 21/952; G01N 35/04

(52) U.S. Cl. CPC G01N 21/8806; B65G 15/14; B65G 37/005; B65G 47/2445; G01N 21/952; G01N 35/04; B65G 2203/041; G01N 2035/0477; G01N 2035/0491

(57) ABSTRACT

A system and method for the inspection of cylindrical containers, the system comprises a conveyor device having a first conveyor chain and a second conveyor chain that are spaced apart and parallel to each other to move cylindrical containers therebetween; a control module to operate the two conveyor chains at different speeds; a position mechanism to obtain location position of the conveyor chains; first type and second type of light sources; and a set of cameras comprising a first group of cameras with a field of view oriented towards a lateral side of the cylindrical containers to acquire images of an outer side wall of the cylindrical containers according to a first inspection configuration, and a second group of cameras with a field of view oriented towards a base of the cylindrical containers to acquire images of the base of the cylindrical containers according to a second inspection configuration.

### TECHNICAL FIELD

The present invention generally relates to inspection systems. More in particular, the present invention relates to a system/device and to a method for the inspection of cylindrical containers, such as (empty) bottles, among others.

### BACKGROUND OF THE INVENTION

Electronic empty bottle inspectors, also referred to ASEBI “all surface bottle empty inspection” are used in the beverage industry to assure that only clean, non-damaged (not broken/chipped) bottles go through the filling process. These machines are installed after the bottle washer and before the filler. Any bottle that does not meet the quality standard is rejected before reaching the filler.

The usual standard inspection requirements usually are: base inspection; external side walls; residual liquid detection; finish/thread.

Because bottles are transported from one machine process to the next on a conveyor device, the bottle base inspection requires a special bottle handling so that the illumination is produced from the bottom of the bottle while a camera captures the image from the top looking down. Therefore, the bottle must be lifted/levitated.

Concerning the external side walls, there are challenges due to the blind zones at the edges of the bottles as they flow on the conveyor device. To address this limitation, multiple cameras are employed, and the inspection process is carried out at multiple stations. For instance, the bottle undergoes an initial inspection at the first station. Then, a 90° rotating mechanism, often implemented with lateral bands, reorients the bottle, enabling it to be inspected again at a second station.

Therefore, there is a need for new and more reliable inspection systems for bottles, or other cylindrical containers. This systems should incorporate simpler mechanisms and be cost-effective in terms of maintenance.

### DESCRIPTION OF THE INVENTION

To that end, embodiments of the present invention provide, according to a first aspect, a system/device for the inspection of cylindrical containers (e.g. bottles, cans, etc.). The system comprises a conveyor device that comprises a first conveyor chain and a second conveyor chain that are disposed spaced apart (i.e. with a gap between them), parallel, and with an inclination with respect to each other, and that are configured to move the cylindrical containers therebetween in a transport direction; a control module for operating at least one of the cited conveyor chains to cause the first and second conveyor chains to move at different speeds, such that the cylindrical containers can be rotated along their vertical axis in a stable and controlled manner while moving along the first and second conveyor chains; a position mechanism attached to any of conveyor chains, or to both, to obtain location position thereof, and also of the cylindrical containers; a set of cameras, operatively connected with the control module, and comprising a first group of cameras with a field of view oriented towards a lateral side of the cylindrical containers to acquire images of an outer side wall of the cylindrical containers according to a first inspection configuration, and a second group of cameras with a field of view oriented towards a base of the cylindrical containers to acquire images of the base of the cylindrical containers according to a second inspection configuration; a first type of light sources, arranged facing the first group of cameras, on another side of the conveyor device, and configured to illuminate a lateral side view of the cylindrical containers; and a second type of light sources, arranged facing the second group of cameras, and configured to illuminate the base of the cylindrical containers.

The present invention also provides, according to a second aspect, a method for the inspection of cylindrical containers on a conveyor device. The method comprises moving one or more cylindrical containers between a first conveyor chain and a second conveyor chain of the conveyor device in a transport direction, the first conveyor chain and the second conveyor chain being disposed spaced apart, parallel, and with an inclination with respect to each other, and the first conveyor chain and the second conveyor chain being moved at different speeds using a control module, such that the one or more cylindrical containers can be rotated along their vertical axis in a stable and controlled manner while moving; providing, by at least one position mechanism attached to the first conveyor chain and/or the second conveyor chain, location position thereof; and submitting the one or more cylindrical containers to two inspection configurations using a set of cameras, comprising a first group of cameras and a second group of cameras, in cooperation with corresponding (side and base) light sources, a first inspection configuration comprising acquiring images of an outer side wall of the cylindrical containers using the first group of cameras, the latter having its field of view oriented towards a lateral side of the cylindrical containers, and a second inspection configuration comprising acquiring images of the base of the cylindrical containers using the second group of cameras, the latter having its field of view oriented towards the base of the cylindrical containers.

The first group of cameras and the second group of cameras can comprise two or more cameras.

In some embodiments, the first inspection configuration is offset with respect to the second inspection configuration. That is, the two inspection configurations are misaligned or desynchronized.

In some embodiments, the first inspection configuration comprises acquiring, by each one of the first group of cameras, an image of the cylindrical containers, each image being acquired at a given rotation interval of the cylindrical containers. For example, if the first group consists of three cameras, this process can result in the acquisition of 12 different views or images, each taken at a 30-degree rotation interval of the cylindrical containers.

Furthermore, the second inspection configuration can comprise acquiring, by each one of the second group of cameras, an image of the cylindrical containers at a different rotation interval of the cylindrical containers. For example, and following the previous example, if the second group consists of three cameras, each view or image is taken at every 60-degree rotation interval of the cylindrical containers.

In any case, in the present invention, the specific number of views acquired/taken by each camera will be a function of the rotation, number of cameras, and type of the cylindrical containers.

In some embodiments, either the first conveyor chain or the second conveyor chain is adjustable to different angles of inclination.

In some embodiments, the second conveyor chain is disposed inclined with respect to the first conveyor chain, or vice versa (i.e. the first conveyor chain is inclined with respect to the second conveyor chain). In some embodiments, the angle of inclination is equal or less than 5 degrees. In some other embodiments, the angle of inclination is comprised between 0.5-5 degrees. In a particular embodiment, the angle of inclination is about 2 degrees.

In some embodiments, the conveyor device further includes an arrangement of magnets arranged under the conveyor chain that is disposed inclined with respect to the other, the arrangement of magnets comprising a plurality of magnets extending in the transport direction of the inclined conveyor chain.

In some embodiments, the position mechanism comprises a motor drive and a pulse encoder. Alternatively, the pulse encoder can be built-in in the motor drive.

According to the invention, the one or more cylindrical containers can be made of glass, plastic, metal, wood, cork, among others.

The present invention does not have band mechanisms or star wheel mechanisms to carry out the inspections. The invention makes the containers rotate on their axis by controlling the speeds of the two chains, and it acquires images at different angles and positions on their side wall and on the base, while the cylindrical containers are within the field of view of the cameras.

By not having bands or star wheel, the mechanics of the inspection system are simpler and there are lower maintenance costs. Likewise, unlike belt systems, it is not necessary to create a separation between the cylindrical containers to perform the inspection of the external wall.

This causes the conveyor chains to move at a much lower linear velocity, making container handling and rejection smoother and safer.

### BRIEF DESCRIPTION OF THE DRAWINGS

The previous and other advantages and features will be more fully understood from the following detailed description of embodiments, with reference to the attached figures, which must be considered in an illustrative and non-limiting manner, in which:

FIG. 1 schematically illustrates a cross sectional view of the proposed inspection system/device, according to an embodiment of the present invention.

FIG. 2 schematically illustrates a top view of the proposed inspection system/device.

### DETAILED DESCRIPTION OF THE INVENTION AND OF PREFERRED EMBODIMENTS

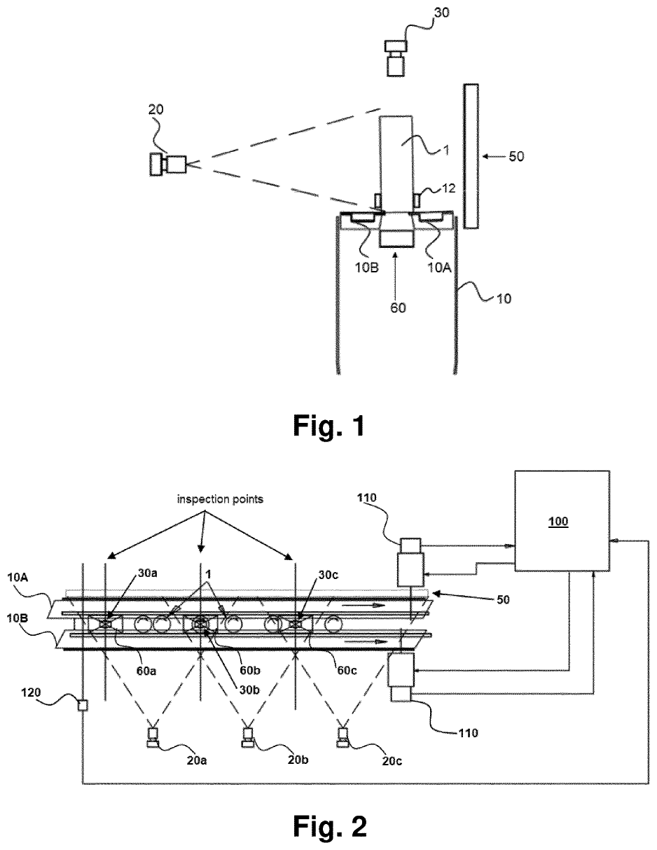

The present invention provides an inspection system/device for (empty) bottles, among other cylindrical containers. An example of the proposed inspection system/device is shown in FIGS. 1 and 2. According to this embodiment, the system includes a special controlled conveyor device 10 with a doble-conveyor chain that allows for the cylindrical containers 1 (from now on simply containers) to be transported while rotating along its vertical axis in a stable and controlled manner.

The inspection system also includes a control module 100 such as a programable processor to operate the doble-conveyor chain, a position mechanism 110, a trigger mechanism 120 such as a photocell, and cameras 20, 30 with its associated light sources 50, 60 such as LEDs or the like to inspect the containers 1. FIG. 1 also illustrates the lateral guides 12 that enable the containers 1 to be maintained centered between the two conveyor chains 10A, 10B.

The two conveyor chains 10A, 10B of the doble-conveyor chain are parallel to each other and spaced apart, with a gap in between. The gap, as will be explained in greater detail below, allows for an opening under the conveyor device 10 to inspect the containers 1 in their base area.

Likewise, the two conveyor chains 10A, 10B have an inclination with respect to each other. More in particular, the conveyor chain 10A is disposed with a given angle of inclination. The angle of inclination can be adjusted by the control module 100, and is particularly comprised between 0.5 and 5 degrees. In some other embodiments the angle is between 0.5 and 2 degrees. In a particular embodiment, such angle of inclination is approximately 2 degrees.

The two conveyor chains 10A, 10B can be controlled independently by the control module 100 (i.e. they can be moved at different speeds). Consequently, the containers 1 can move along the conveyor device 10 while they rotate. Because the gap between the two conveyor chains 10A, 10B is the same throughout the inspection regions, the rotation allows multiple inspection stations of the containers 1 with redundancy and without any blind spot.

Particularly, the speed at which the conveyor chain 10A (i.e. the inclined conveyor chain) is moved is higher than the speed at which the conveyor chain 10B is moved. In any case, it should be noted that the difference in speed of the two conveyor chains 10A, 10B will mainly depend on the diameter of the container 1 and on the angle at which it is to be rotated.

The position mechanism 110 can consist of a variety of combinations, such as a motor drive and encoder or a motor drive with a built-in encoder. It's important to note that while in FIG. 2 the position mechanism 110 comprises two separate modules, one for each conveyor chain, in other embodiments, not shown, it can be a single module attached to the inclined conveyor chain 10A.

The position mechanism 110 is interconnected with the control module 100 to provide position information about the chains, and also about the containers 1, to the control module 100. This mechanism allows for achieving position errors in the containers 1 of less than 3%. This level of precision enables multiple inspections of the base and outer side wall of the containers 1 at varying rotational intervals of the containers.

With regard to the cameras 20, 30, particularly, these are divided into two groups: a first group of cameras 20 (or side/lateral cameras) and a second group of cameras 30 (or top cameras). In the illustrated embodiment, each group of cameras comprises three cameras, however it's important to note that this arrangement is not limiting. In other embodiments, each group can contain a different number of cameras, either more or less, for instance two, four, five, etc.

The side/lateral cameras 20a, 20b, 20c are disposed on one side of the conveyor device 1 with their field of view positioned and oriented towards the lateral side of the containers 1 to acquire images of an outer side wall of the containers 1. On the other hand, the top cameras 30a, 30b, 30c are positioned over the containers 1 with their field of view oriented towards the base of the containers 1 through the finish “lip/collar” to acquire images of the base. This inspection captures the image of the base of the containers 1 from the inside.

The (side) light sources 50 (or first type of light sources) are situated on the opposite side of the conveyor device 10, facing the side/lateral cameras 20a, 20b, 20c, and thus creating a back light illumination, and are configured to illuminate a lateral side view of the containers 1. The (base) light source 60 (or second type of light sources) are arranged facing the top cameras 30a, 30b, 30c and are configured to illuminate the base of the containers 1, located under the containers 1 and thus creating a back light illumination.

In the illustrated embodiment, the inspection of the base of the containers 1 is performed as follows. The containers 1 are transported along the two conveyor chains 10A, 10B and are rotated along their vertical axis in a controlled manner. The trigger mechanism 120 is configured to detect the containers 1 passing in front of it. At the same time, the control module 100 can track the movement of the container 1 along the conveyor device 10 using the position mechanism 110, particularly the encoder pulses.

When a given container 1 is detected at a first inspection zone, referred as zone “a”, at which top camera 30a and light 60a are situated, a first image is captured, that can be denoted as base image “a”. This process is repeated at a second position, referred as zone “b”, at which top camera 30b and light 60b are situated, providing in this case a second image of the base, denoted as base image “b”. It should be noted that because of the container rotation, this second inspection zone “b” is at the point where the given container 1 has rotated very close to 60 degrees with relative to zone “a”. The process is also repeated at a third position, referred as zone “c”, at which top camera 30c and light 60c are situated, providing a third base image “c”. Again, since the given container 1 is rotating while being transported, this third inspection zone “c” is at the point where the container 1 has rotated very close to 60 degrees with relative to zone “b” and 180 degrees relative to zone “a”. Because of the controlled rotation of the given container 1, the three image of the base “a”, “b” and “c” collectively ensure a complete inspection of the base area of the given container 1.

With regard to the outer side wall inspection of the containers 1, in the illustrated embodiment this can be performed as follows. When a given container 1 falls within the field of view of the side/lateral cameras 20a, 20b, 20c each of these cameras is configured to acquire an image of the outer side wall of the given container 1. Again, because of the rotation of the given container 1, each of these lateral images will be acquired at a different rotation interval. Particularly, each image will be captured at 30-degree intervals.

Thus, in this particular embodiment, the first inspection configuration encompasses twelve views of the outer side walls, with each view captured at 30-degree intervals, while the second inspection configuration involves three views of the base, acquired at 60-degree intervals. Nevertheless, this example is not intended to be restrictive. As previously explained, the proposed inspection system can incorporate a varying number of cameras, resulting in differing views and acquisition rotation intervals to accommodate different inspection requirements. Actually, it's important to highlight that the quantity of views acquired by the cameras depends on the number of cameras present in each group, the rotation of the containers 1 (as determined by the position mechanism 110 and the specific type of container 1. In other words, the number of views required for a dependable inspection can vary depending on the container type. Some containers 1 may necessitate more views, while others may require fewer to ensure a reliable inspection.

For instance, in other embodiments, the complete base inspection (i.e. the 360-degree) can be assured by only using two inspection zones, i.e. two top cameras and corresponding lights, such that the two base images are acquired at 90-degree rotation intervals. The same is possible for the complete outer side wall inspection of the containers wall using two side cameras only, such that the lateral images of the containers are acquired with a 180-degree rotation interval.

In some embodiments, the proposed inspection system may also include an arrangement of magnets, which are particularly placed under the conveyor chain 10A. The arrangement of (equidistant or variable-spaced) magnets enables that the angle of inclination is kept stable. Likewise, it also prevents the conveyor chain 10A from separating from the chain guides.

Present invention also provides a method for inspection of cylindrical containers 1, using the above-described inspection system/device. In an embodiment, the containers 1 are precisely transported between the first conveyor chain 10A and the second conveyor chain 10B, within the gap between both conveyor chains. They move in a controlled manner in a direction of transport while rotating steadily along their vertical axis. Simultaneously, the position mechanism 110 provides the positional information of the chains and the containers 1. During this process, inspection of the containers 1 is executed using two inspection configurations. The first configuration involves the use of the first group of cameras 20 in conjunction with the corresponding light source(s) 50. This configuration ensures comprehensive coverage of the entire external side wall of the containers 1 by capturing distinct images at various rotational intervals. At the same time, as the containers 1 are in motion and undergoing rotation, the second inspection configuration utilizes the second group of cameras 30 in combination with the corresponding light sources 60. This configuration ensures complete coverage of the base of the containers 1 by acquiring distinct images of the base at different rotational intervals.

The scope of the present invention is defined in the appended claims.

1. A system for the inspection of cylindrical containers, comprising:
a conveyor device (10), comprising a first conveyor chain (10A) and a second conveyor chain (10B), which are disposed spaced apart, parallel, and with an inclination with respect to each other, and which are configured to move one or more cylindrical containers (1) therebetween in a transport direction;
a control module (100) configured to operate at least one of said first conveyor chain (10A) and said second conveyor chain (10B) to cause the first and second conveyor chains (10A, 10B) to move at different speeds, such that the one or more cylindrical containers (1) can be rotated along their vertical axis in a stable and controlled manner while moving along the first and second conveyor chains (10A, 10B);
at least one position mechanism (110) attached to the first conveyor chain (10A) and/or the second conveyor chain (10B) to obtain location position thereof;
a set of cameras (20, 30), operatively connected with the control module (100), and comprising a first group of cameras (20) with a field of view oriented towards a lateral side of the cylindrical containers (1) to acquire images of an outer side wall of the cylindrical containers (1) according to a first inspection configuration, and a second group of cameras (30) with a field of view oriented towards a base of the cylindrical containers (1) to acquire images of the base of the cylindrical containers (1) according to a second inspection configuration;
a first type of light sources (50), arranged facing the first group of cameras (20), on another side of the conveyor device (10), and configured to illuminate a lateral side view of the cylindrical containers (1); and
a second type of light sources (60), arranged facing the second group of cameras (30), and configured to illuminate the base of the cylindrical containers (1).

2. The system of claim 1, wherein each one of the first group of cameras (20) and the second group of cameras (30) comprises at least two cameras.

3. The system of claim 1, wherein the first inspection configuration is offset with respect to the second inspection configuration.

4. The system of claim 1, wherein the first inspection configuration comprises acquiring a plurality of images of the cylindrical containers (1), each one of the images being acquired at a given rotation interval of the cylindrical containers (1) using the first group of cameras.

5. The system of claim 1, wherein the second inspection configuration comprises acquiring a plurality of images of the cylindrical containers (1) that are acquired at different rotation intervals of the cylindrical containers (1) using the second group of cameras (30).

6. The system of claim 1, wherein either the first conveyor chain (10A) or the second conveyor chain (10B) is adjustable to different angles of inclination.

7. The system of claim 1, wherein the second conveyor chain (10B) is disposed inclined with respect to the first conveyor chain (10A), or vice versa, an angle of inclination being comprised between 0.5 and 5 degrees.

8. The system of claim 1, further comprising an arrangement of magnets arranged under the conveyor chain that is disposed inclined with respect to the other, the arrangement of magnets comprising a plurality of magnets extending in the transport direction of the inclined conveyor chain.

9. The system of claim 1, wherein the position mechanism (110) comprises a motor drive and a pulse encoder or a motor drive with a built-in encoder.

10. A method for the inspection of cylindrical containers, comprising:
moving one or more cylindrical containers (1) between a first conveyor chain (10A) and a second conveyor chain (10B) of a conveyor device (10) in a transport direction, the first conveyor chain (10A) and the second conveyor chain (10B) being disposed spaced from, parallel, and with an inclination with respect to each other, and the first conveyor chain (10A) and the second conveyor chain (10B) being moved at different speeds using a control module (100), such that the one or more cylindrical containers (1) can be rotated along their vertical axis in a stable and controlled manner while moving;
providing, by a position mechanism (110) attached to the first conveyor chain (10A) and/or the second conveyor chain (10B), location position thereof; and
submitting the one or more cylindrical containers (1) to two inspection configurations using a set of cameras (20, 30), comprising a first group of cameras (20) and a second group of cameras (30), in cooperation with corresponding light sources (50, 60), a first inspection configuration comprising acquiring images of an outer side wall of the cylindrical containers (1) using the first group of cameras (20), the latter having its field of view oriented towards a lateral side of the cylindrical containers (1), and a second inspection configuration comprising acquiring images of a base of the cylindrical containers (1) using the second group of cameras (30), the latter having its field of view oriented towards the base of the cylindrical containers (1).

11. The method of claim 10, wherein each one of the first group of cameras (20) and the second group of cameras (30) comprises at least two cameras.

12. The method of claim 10, wherein the first inspection configuration is offset with respect to the second inspection configuration.

13. The method of claim 10, wherein the first inspection configuration comprises acquiring a plurality of images of the cylindrical containers (1), each one of the images being acquired at a given rotation interval of the cylindrical containers (1) using the first group of cameras (20).

14. The method of claim 10, wherein the second inspection configuration comprises acquiring a plurality of images of the cylindrical containers (1), each one of the images being acquired at a given rotation interval of the cylindrical containers (1) using the second group of cameras (30).

15. The method of claim 10, comprising disposing the second conveyor chain (10B) inclined with respect to the first conveyor chain (10B), or vice versa, with an angle of inclination between 0.5 and 5 degrees.

16. The method of claim 10, further comprising placing an arrangement of magnets under the conveyor chain that is disposed inclined with respect to the other, the arrangement of magnets comprising a plurality of magnets extending in the transport direction of the inclined conveyor chain.
